(19) United States
(12) Patent Application Publication
(10) Pub. No.: US 2021/0359827 A1
(43) Pub. Date: Nov. 18, 2021

(54) MULTIPLEXING OF IAB-NODE LINKS

(71) Applicant: Telefonaktiebolaget LM Ericsson (publ), Stockholm (SE)

(72) Inventors: Yezi HUANG, Täby (SE); Erik DAHLMAN, Stockholm (SE); Boris DORTSCHY, Hägersten (SE); Per-Erik ERIKSSON, Stockholm (SE)

(21) Appl. No.: 17/277,473

(22) PCT Filed: Sep. 27, 2019
(86) PCT No.: PCT/EP2019/076249

§ 371 Date: Mar. 18, 2021

Related U.S. Application Data
(60) Provisional application No. 62/737,580, filed on Sep. 27, 2018.

(51) Int. Cl. H04L 5/00; H04B 7/155; H04L 5/14

(52) U.S. Cl. CPC H04L 5/0094; H04L 5/14; H04B 7/15542

(57) ABSTRACT

A method, system and apparatus in a network node configured as an integrated access backhaul, IAB, node to communicate with a parent node and a child node and or a wireless device (WD) is provided. According to one aspect, the process includes, if a collision occurs between a scheduling grant for an uplink parent backhaul and an already issued scheduling grant for an uplink child backhaul, then one of: transmitting on an uplink parent backhaul and ignore possible uplink transmission from the child node and/or the WD; and ignoring a scheduling grant from the parent node and not transmit on an uplink parent backhaul.

### FIELD

The present disclosure relates to wireless communications, and in particular, to multiplexing integrated access backhaul (IAB)-node links.

### INTRODUCTION

In a wireless relay communication network, some wireless devices (WD) connect to the network via relay nodes. Within the Third Generation Partnership Project (3GPP), the term Integrated Access Backhaul (IAB) is used to refer to such a wireless relay network based on the New Radio (NR), or 5G, radio-access technology. In FIG. 1, an IAB deployment is presented, where an IAB donor node (in short, IAB donor) has a wired connection to the core network and IAB relay nodes (in short, IAB nodes, shown in FIG. 1 as IAB node 1 and IAB node 2) are wirelessly connected using NR to the IAB donor, either directly or indirectly via another IAB node. The connection between IAB donor/node and WDs is called an access link. The connection between two IAB nodes or between an IAB donor and an IAB node is called a backhaul link. For the IAB network, the backhaul links may be implemented as NR wireless links.

As shown in FIG. 2, for a given IAB node there are six different types of links including:

L_{P,DL}: The downlink backhaul link from a parent node (a donor node or another IAB node) to the IAB node (IAB node downlink reception)—transmitted by the parent node and received by the IAB node;

L_{P,UL}: The uplink backhaul link from the IAB node to the parent node (IAB node uplink transmission)—transmitted by the IAB node and received by the IAB parent node;

L_{C,DL}: The downlink backhaul link from the IAB node to a child (IAB) node (IAB node downlink transmission)—transmitted by the IAB node and received by the child IAB node;

L_{C,UL}: The uplink backhaul link from a child node to the IAB node (IAB node uplink reception)—transmitted by the child IAB node and received by the IAB node;

L_{A,DL}: The downlink access link to a WD served by the IAB node (IAB node downlink transmission)—transmitted by the IAB node and received by the wireless device; and

L_{A,UL}: The uplink access link from a WD served by the IAB node (IAB node uplink reception)—transmitted by the wireless device and received by the IAB node.

The different types of links of an IAB node can be multiplexed together. There are three different ways by which such multiplexing might be accomplished:
In the time-domain (time-domain multiplexing or TDM) where different link types are separated in time, i.e., transmission takes place in different time resources, for example different slots;
In the frequency-domain (frequency-domain multiplexing or FDM) where different link types are separated in frequency, i.e., transmission takes place in different frequency-domain resources, for example different frequency-domain resource blocks as defined as part of the NR specifications; and
In the spatial domain (spatial-domain multiplexing or SDM), where different link types are separated for example by means of transmission or reception in different antenna panels or by means of different beams of the same antenna panel.

There are (at least) three factors and potential limitations that it might be desirable to take into account when considering the assignment of transmission resources to the different links of an IAB node:
The node capability, for example: whether an IAB node is capable of full duplex (simultaneous transmission and reception) or limited to half-duplex operation (simultaneous transmission/reception not possible), whether an IAB node uses analog or digital beamforming, etc.;
The possible lack of timing alignment between different links. This may, for example, limit the extent by which different link types can be multiplexed by means of FDM/SDM within the same antenna panel of an IAB node; and
Management of cross-link interference (CLI). There may, for example, be a need/desire to limit the scheduling of WD uplink transmissions to certain time resources in order to avoid direct device-to-device interference as illustrated in FIG. 3.

Note that the extent of these limitations may depend on, for example:
The IAB node's capabilities, which may vary between different IAB nodes; and
Different deployment strategies, for example, the need for avoidance of direct WD-to-WD interference as illustrated in FIG. 3, may vary between different deployments.

There is thus a need for a flexible mechanism to configure the multiplexing of different links of the IAB node.

### SUMMARY

Some embodiments advantageously provide methods, systems, and apparatuses for configuring integrated access backhaul (IAB)-node links.

Some embodiments configure the IAB nodes in a multi-hop IAB network with different sets having time-domain resources, for example, slots. Each of the sets restricts certain behavior of the IAB node in terms of transmission and/or reception of the different types of links. A given time resource can belong to zero, one or multiples of the predefined sets. Within the constraints of the configured resource sets, the IAB node can flexibly multiplex and schedule its child links (L_{C,DL}, L_{C,UL}, L_{A,DL} and L_{A,UL}) depending on the node capability and real-time demands. This makes it possible to adjust to different limitations as the ones described above while still keeping a high-degree of flexibility for the IAB-node scheduler, enabling high efficiency in terms of resource utilization at the IAB node.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of an IAB deployment;

FIG. 2 is a diagram of an IAB deployment showing different link types;

FIG. 3 is a diagram an IAB deployment showing device to device interference;

FIG. 4 is a schematic diagram of an exemplary network architecture illustrating a communication system connected via an intermediate network to a host computer according to the principles in the present disclosure;

FIG. 5 is a block diagram of a host computer communicating via a network node with a wireless device over an at least partially wireless connection according to some embodiments of the present disclosure;

FIG. 6 is a flow chart illustrating exemplary methods implemented in a communication system including a host computer, a network node and a wireless device for executing a client application at a wireless device according to some embodiments of the present disclosure;

FIG. 7 is a flow chart illustrating exemplary methods implemented in a communication system including a host computer, a network node and a wireless device for receiving user data at a wireless device according to some embodiments of the present disclosure;

FIG. 8 is a flow chart illustrating exemplary methods implemented in a communication system including a host computer, a network node and a wireless device for receiving user data from the wireless device at a host computer according to some embodiments of the present disclosure;

FIG. 9 is a flow chart illustrating exemplary methods implemented in a communication system including a host computer, a network node and a wireless device for receiving user data at a host computer according to some embodiments of the present disclosure;

FIG. 10 is a flowchart of an exemplary process in a parent node configured to communicate with an IAB node according to some embodiments of the present disclosure; and

FIG. 11 is a diagram of an IAB deployment where collisions may occur.

FIG. 12 is a flowchart of an exemplary process in a network node configured as an IAB node according to some embodiments of the present disclosure;

### DETAILED DESCRIPTION

Before describing in detail exemplary embodiments, it is noted that the embodiments reside primarily in combinations of apparatus components and processing steps related to configuring integrated access backhaul (IAB)-node links. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

Note that although terminology from one particular type of wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

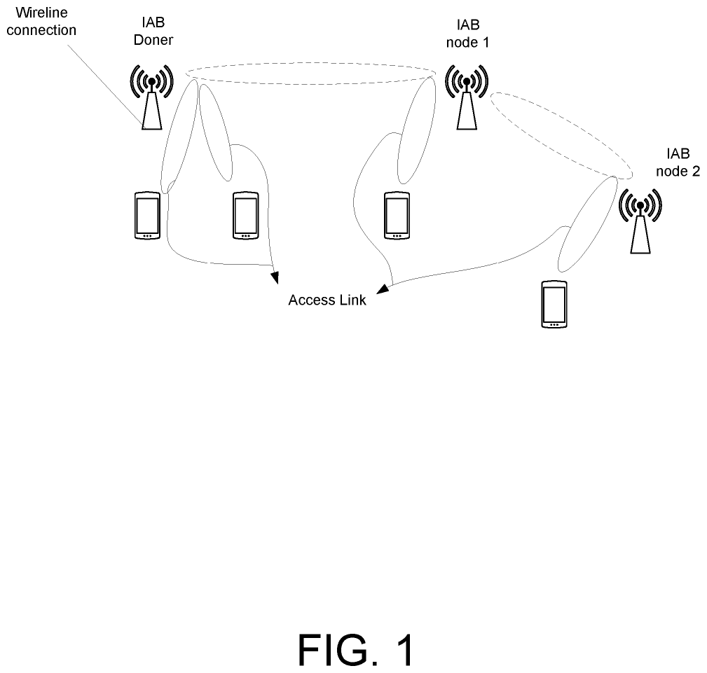

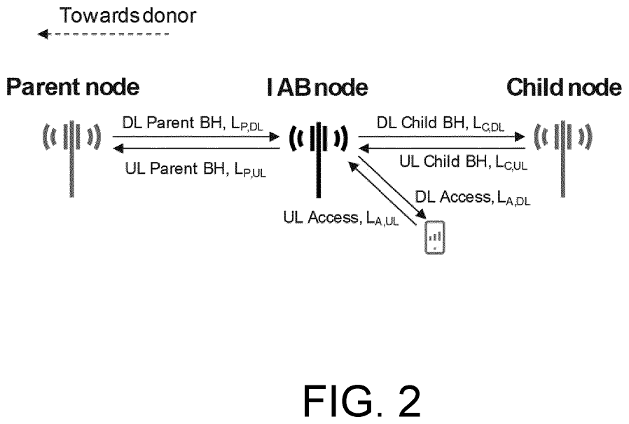

Multiplexing different link types of an intermediate node in a multi-hop network, e.g., an IAB network, requires coordination between different nodes to avoid cross-link interference as well as fulfill certain constraints at each node. One way to achieve this is to configure each time resource with one or multiple link types noted in FIG. 1, given the profiles of each node, such as the traffic demands, the node capabilities, etc., which, however, requires large signaling overhead and lacks flexibility. Some embodiments include configuring the IAB node with different sets of time-domain resources which define the baseline service the IAB node should preferably provide on a certain link type without limiting the possibility of multiplexing the other link types. The set-based configuration can be done without knowing the capability of each IAB node. Within the constraints of the configured sets, the IAB node has a high-degree of flexibility to multiplex and schedule its child links in a most efficient way according to its capability and real-time demands while keeping coordination between the IAB nodes and the parent nodes.

According to the embodiments herein, an IAB node is configured with different resource sets, each set consisting of a set of time-domain resources, where a time-domain resource may, for example, correspond to a slot. Within the constraints of the configured resource sets, the IAB node can flexibly schedule its child links but still keeps coordination between the IAB nodes and the parent node. The parent node configures the time resources which belong to different pre-defined resource sets to restrict the behavior of the IAB node in different ways, which also implies the degree of freedom that the IAB node can assume to configure and schedule its child links in a most efficient way.

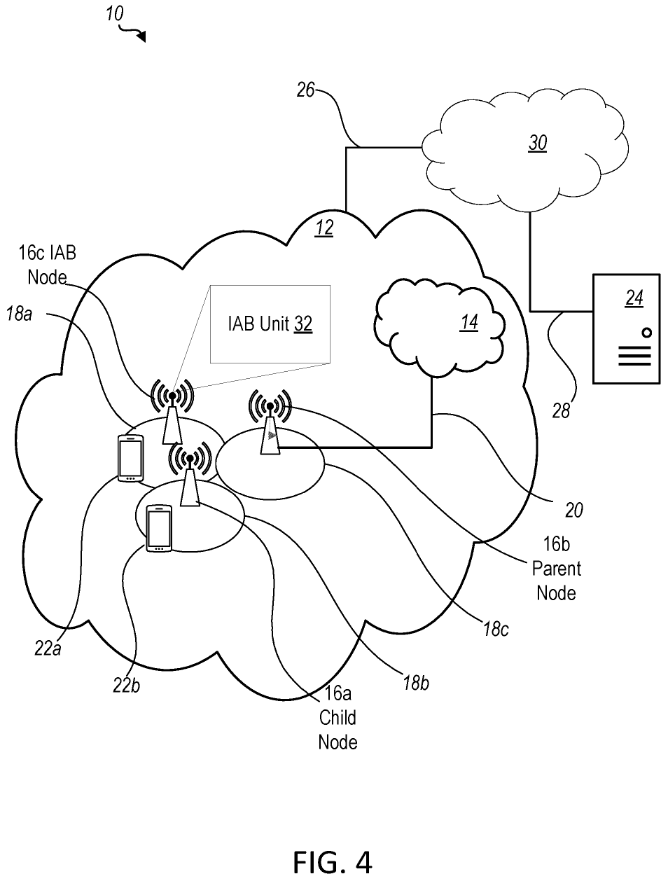

Referring now to the drawing figures, in which like elements are referred to by like reference numerals, there is shown in FIG. 4 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. Also, network node 16a may be a child node, network node 16b may be a parent node, and network node 16c may be an IAB node. It is noted that the terms ‘parent node’ and ‘child node’ are defined, in this example, relative to the network node 16c. A first wireless device (WD) 22a located in coverage area 18a is configured to wirelessly connect to, or be paged by, the corresponding network node 16c. A second WD 22b in coverage area 18b is wirelessly connectable to the corresponding network node 16a. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 4 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a.

Similarly, the network node 16 need not be aware of the future routing of an outgoing uplink communication originating from the WD 22a towards the host computer 24.

A network node 16 is configured to include a IAB unit 32 which is configured to one of transmit on an uplink parent backhaul and ignore possible uplink transmission from a child node and or a WD, and ignore a scheduling grant from the parent node and not transmit on an uplink parent backhaul.

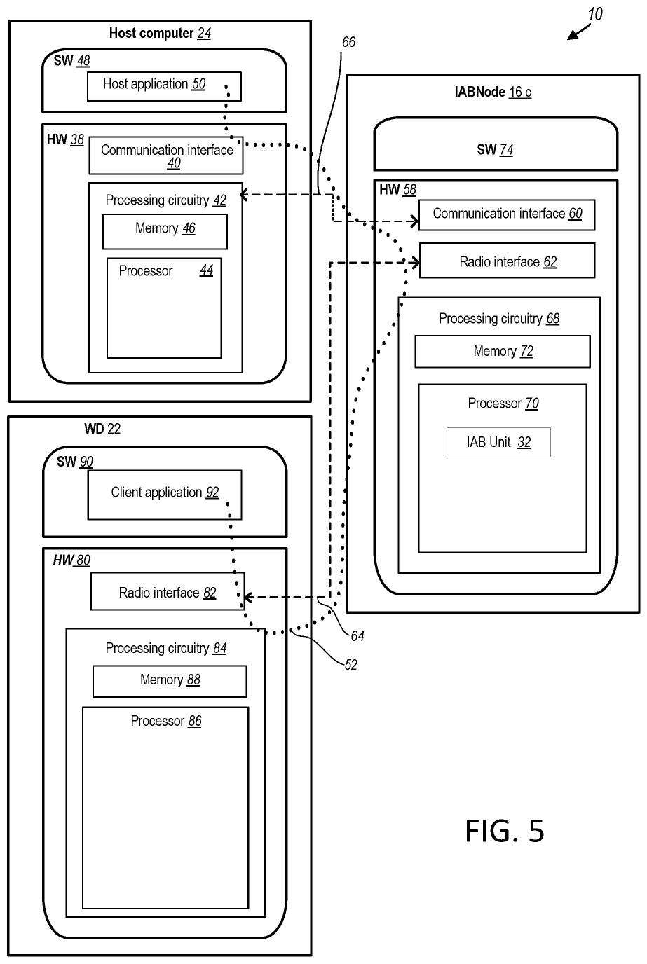

Example implementations, in accordance with an embodiment, of the WD 22, network node 16 and host computer 24 discussed in the preceding paragraphs will now be described with reference to FIG. 5. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. It is noted that the elements shown in FIG. 5 for the network node 16 are not limited solely to the IAB node 16c. Rather the elements shown in FIG. 5 may also apply to the child node 16a and/or the parent node 16b. In other words, the elements shown in FIG. 5 may apply regardless of whether the network node 16 is functioning as an IAB node 16c, a child node 16a or a parent node 16b. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include IAB unit 32 configured to one of transmit on an uplink parent backhaul and ignore possible uplink transmission from a child node and or a WD, and ignore a scheduling grant from the parent node and not transmit on an uplink parent backhaul.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22.

In some embodiments, the inner workings of the IAB node 16c, WD 22, and host computer 24 may be as shown in FIG. 5 and independently, the surrounding network topology may be that of FIG. 4.

In FIG. 5, the OTT connection 52 has been drawn abstractly to illustrate the communication between the host computer 24 and the wireless device 22 or child node 16a via the IAB node 16c, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 or child node 16a and the IAB node 16c is in accordance with the teachings of the embodiments described throughout this disclosure. One or more of the various embodiments can improve the performance of OTT services provided to the WD 22 or child node 16a using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22 or child node 16a, in response to variations in the measurement results. Henceforth, reference will be made to network node 16 and WD 22, with the understanding that reference to network node 16 may refer to the IAB node 16c and reference to the WD 22 may also refer to the child node 16a.

The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 4 and 5 show various “units” such as the IAB unit 32 as being within a respective processor, it is contemplated that these units may be implemented such that a portion of the unit is stored in a corresponding memory within the processing circuitry. In other words, the units may be implemented in hardware or in a combination of hardware and software within the processing circuitry.

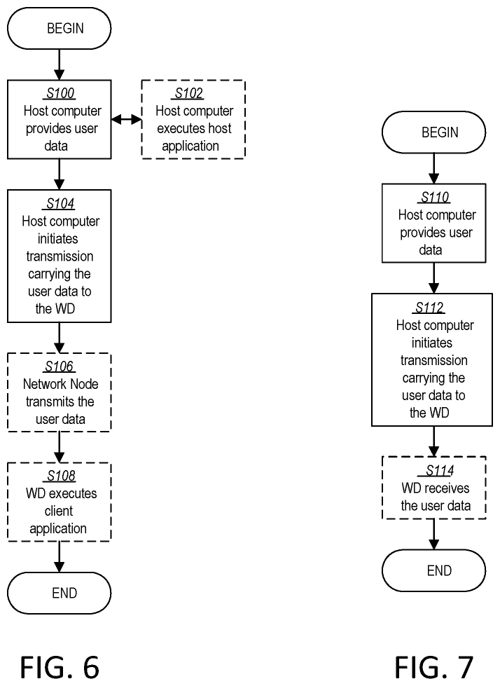

FIG. 6 is a flowchart illustrating an exemplary method implemented in a communication system, such as, for example, the communication system of FIGS. 4 and 5, in accordance with one embodiment. The communication system may include a host computer 24, a network node 16 and a WD 22, which may be those described with reference to FIG. 5. In a first step of the method, the host computer 24 provides user data (block S100). In an optional substep of the first step, the host computer 24 provides the user data by executing a host application, such as, for example, the host application 74 (block S102). In a second step, the host computer 24 initiates a transmission carrying the user data to the WD 22 (block S104). In an optional third step, the network node 16 transmits to the WD 22 the user data which was carried in the transmission that the host computer 24 initiated, in accordance with the teachings of the embodiments described throughout this disclosure (block S106). In an optional fourth step, the WD 22 executes a client application, such as, for example, the client application 114, associated with the host application 74 executed by the host computer 24 (block S108).

FIG. 7 is a flowchart illustrating an exemplary method implemented in a communication system, such as, for example, the communication system of FIG. 4, in accordance with one embodiment. The communication system may include a host computer 24, a network node 16 and a WD 22, which may be those described with reference to FIGS. 4 and 5. In a first step of the method, the host computer 24 provides user data (block S110). In an optional substep (not shown) the host computer 24 provides the user data by executing a host application, such as, for example, the host application 74. In a second step, the host computer 24 initiates a transmission carrying the user data to the WD 22 (block S112). The transmission may pass via the network node 16, in accordance with the teachings of the embodiments described throughout this disclosure. In an optional third step, the WD 22 receives the user data carried in the transmission (block S114).

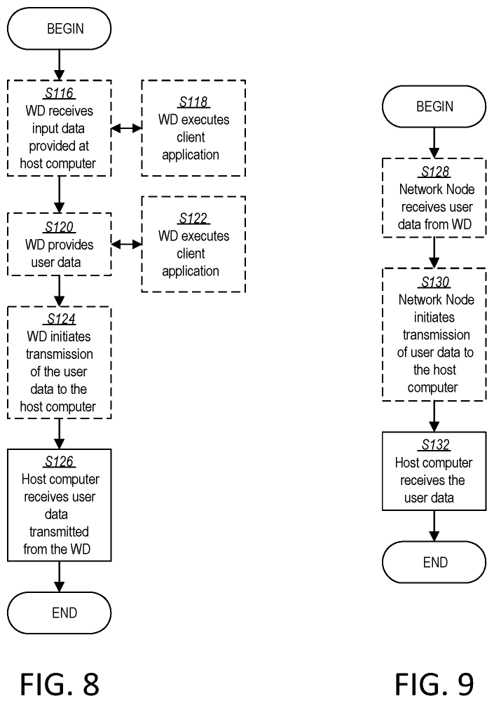

FIG. 8 is a flowchart illustrating an exemplary method implemented in a communication system, such as, for example, the communication system of FIG. 4, in accordance with one embodiment. The communication system may include a host computer 24, a network node 16 and a WD 22, which may be those described with reference to FIGS. 4 and 5. In an optional first step of the method, the WD 22 receives input data provided by the host computer 24 (block S116). In an optional substep of the first step, the WD 22 executes the client application 114, which provides the user data in reaction to the received input data provided by the host computer 24 (block S118). Additionally or alternatively, in an optional second step, the WD 22 provides user data (block S120). In an optional substep of the second step, the WD provides the user data by executing a client application, such as, for example, client application 114 (block S122). In providing the user data, the executed client application 114 may further consider user input received from the user. Regardless of the specific manner in which the user data was provided, the WD 22 may initiate, in an optional third substep, transmission of the user data to the host computer 24 (block S124). In a fourth step of the method, the host computer 24 receives the user data transmitted from the WD 22, in accordance with the teachings of the embodiments described throughout this disclosure (block S126).

FIG. 9 is a flowchart illustrating an exemplary method implemented in a communication system, such as, for example, the communication system of FIG. 4, in accordance with one embodiment.

The communication system may include a host computer 24, a network node 16 and a WD 22, which may be those described with reference to FIGS. 4 and 5. In an optional first step of the method, in accordance with the teachings of the embodiments described throughout this disclosure, the network node 16 receives user data from the WD 22 (block S128). In an optional second step, the network node 16 initiates transmission of the received user data to the host computer 24 (block S130). In a third step, the host computer 24 receives the user data carried in the transmission initiated by the network node 16 (block S132).

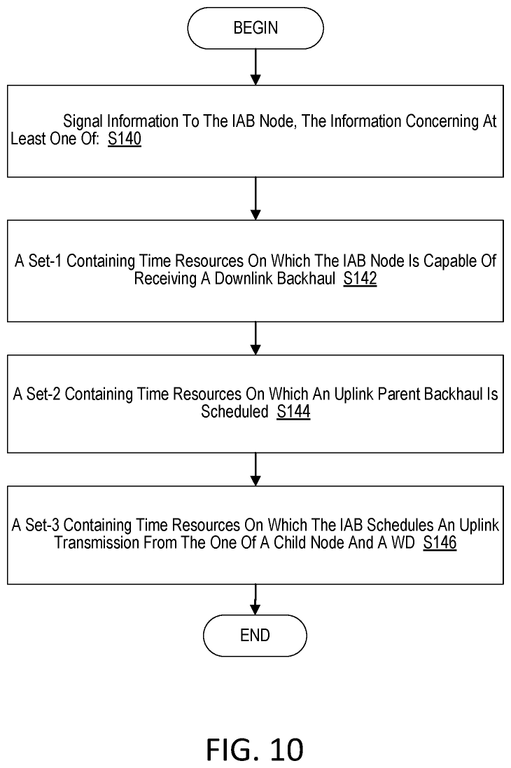

FIG. 10 is a flowchart of an exemplary process performed by a parent IAB node (e.g. IAB node 16b) according to some embodiments of the present disclosure. The process includes signaling information to an IAB node (e.g. IAB node 16c), the information concerning at least one of: a first set (Set-1) containing time resources in which the IAB node is capable of receiving a downlink backhaul; a second set (Set-2) containing time resources in which an uplink parent backhaul might be, or is, scheduled; and a third set (Set-3) containing time resources in which the IAB node is permitted to schedule an uplink transmission from one of a child node and a WD.

Having described the general process flow of arrangements of the disclosure and having provided examples of hardware and software arrangements for implementing the processes and functions of the disclosure, the sections below provide details and examples of arrangements for multiplexing integrated access backhaul (IAB)-node links.

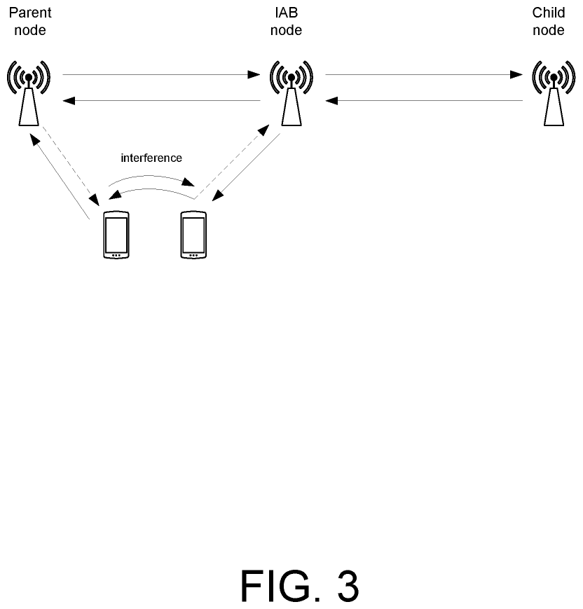

In case of half-duplex constraints, an IAB node 16c cannot be assumed to be able to continuously receive on the backhaul downlink (L_{P,DL} in FIG. 3). Preferably, the parent node 16b should know when the IAB node 16c is able to receive on the downlink, i.e., when downlink transmissions can be scheduled to the IAB node 16c. According to some embodiments, IAB node 16c is configured with a set of time-domain resources (here simply referred to as “Set-1”) in which the parent node 16b can assume that the IAB node 16c can receive the downlink backhaul. Thus, within the time resources of Set-1, the IAB node 16c should, in some embodiments:
have its receiver active, and
configure its receiver antenna in such a way that it can receive a downlink transmission from the parent node 16b. This may include the adjustment of any receiver beam in the direction of the parent node.

Note that the local behavior of the IAB node 16c, in terms of scheduling of child links, may vary depending on the IAB-node capability and operation in terms of duplexing, analog vs. digital beamforming, timing-alignment strategy, etc. IAB node 16c may, due to timing misalignment and/or analog beamforming, only be able to receive on the UL child links (L_{C,UL} and L_{A,UL}) during the time resources defined by Set-1 within a different panel other than the one used for the backhaul link. On the other hand, if the IAB node 16c uses digital beamforming and with links properly time aligned, it could receive on UL child links, even within the same panel as the parent backhaul. With future IAB nodes capable of full-duplexing, the IAB node might, in some embodiments, also transmit on DL child links within the time resources belonging to Set-1.

If an IAB node (e.g. node 16c) is provided with an explicit scheduling grant for uplink transmission (L_{P,UL}) the parent node (e.g. node 16b) is aware of this and can take that into account in the downlink scheduling. Thus, according to some embodiments, an explicit scheduling grant for uplink transmission provided to the IAB node could override the Set-1 restriction applied to that IAB node; that is, if an IAB node has an uplink transmission scheduling grant for a time resource that is included in the configured Set-1, the IAB node may transmit during this time resource even though this may prevent IAB node reception of the downlink backhaul link.

In contrast to the downlink backhaul link L_{P,DL}, there is no absolute need to configure specific time-domain resources when uplink backhaul transmission (L_{P,UL}) can take place. Rather, uplink transmission on the parent backhaul link from an IAB network node can be solely controlled by dynamic scheduling grants provided by the parent IAB node.

Due to, for example, analog transmitter-side beamforming or timing misalignment, simultaneous uplink transmission (L_{P,UL}) and downlink transmission (L_{C,DL}) from the IAB node may not be possible within the same IAB-node antenna panel. However, this can be handled internally within the IAB node by simply not scheduling any downlink transmissions when it has been provided with an uplink scheduling grant and has data available for uplink transmission.

However, if the IAB node is not aware in advance when it may be assigned a scheduling grant for uplink transmission (L_{P,UL}), it may have issued a scheduling of its own for uplink transmission from child nodes (L_{C,UL}). If the IAB node then carries out uplink data transmission according to the scheduling grant provided by the parent, the transmission from the child/UE cannot be received.

To avoid this situation, according to the present disclosure, the IAB node 16c may be configured by the parent IAB node 16b with a set of time resources here referred to as “Set-2”. In practice, the time resources of Set-2 would correspond to time resources where the UL parent link L_{P,UL} may be scheduled.

The inclusion of a time resource in Set-2 would impact the scheduling, by the IAB node 16c, of uplink transmissions from child nodes (e.g. node 16a) and/or WDs (e.g. WD 22a) in that time resource.
In one embodiment, the IAB node 16c would not schedule uplink transmissions from a child node 16a and/or WDs 22 in that time resource.
In another embodiment, the probability of the IAB node 16c scheduling uplink transmissions in that time resource will be reduced, compared to if the time-resource was not included in Set-2. In other words, the IAB node 16c might decrease the likelihood it schedules an uplink transmission from a child node 16a and/or WD 22 within the time resources of Set-2 compared to if those time resources were not included in Set-2.

In this way, the risk for collision between uplink transmissions to the parent node 16b and the reception of uplink transmissions for child node 16a and/or WDs 22 can be reduced or eliminated.

When the IAB node 16c issues scheduling grants to its child node(s) 16a or WDs, it may in addition be based on some prior knowledge, for example, the probability of receiving a scheduling grant from a parent node 16b at a certain time resource, so as to use the time resources more efficiently. In any case, if collision happens between the scheduling grant available for the UL parent backhaul, and the already issued scheduling grant/assignment to the IAB node's child node or WDs, the scheduling collision can be resolved in a pre-defined/on-demand manner. This is further described below.

To avoid cross-link interference as described above in connection with FIG. 3, according to the some embodiments, an IAB node can be configured with a third Set of time-domain resources, here simply referred to as “Set-3”, that indicates the resource in which the IAB node 16c is allowed to schedule uplink transmissions from WDs (link L_{A,UL}). Alternatively expressed, the IAB node 16c should not schedule uplink transmissions from devices/child nodes in time resources not included in Set-3.

Note that, typically, the same resource Set-3 would be configured for all the IAB nodes in a local area.

Upon acquiring resource Set-3, the IAB node 16c may also derive the available resources it can use for DL transmission on access links (L_{A,DL}).

To summarize:

The IAB node 16c can be configured with time resources belonging to zero, one or multiples of the following sets:
Set-1: contains time resources on which the IAB node 16c should be capable of (e.g. be arranged to, or set-up to) receiving the DL backhaul;
Set-2: contains time resources on which the UL parent backhaul might be scheduled; and
Set-3: contains time resources on which the IAB node 16c is allowed to, i.e. is permitted to, schedule uplink transmission from its served WDs and/or child nodes.

Information about the three sets described above can be broadcast by the parent node 16b and be received by all the IAB nodes directly under the parent node. Alternatively, the three sets can be configured separately for the IAB nodes using dedicated signaling, for example RRC signaling or MAC signaling.

Besides the time resources belonging to any of the above three sets, the IAB node 16c can also be configured with time resources that do not belong to any of the sets. In this case, the IAB node 16c can make local decisions on how to multiplex its child links during those time resources and how to react to the scheduling grant/assignment from the parent node 16b.

If collision happens between the scheduling grant available for the UL parent backhaul, and the already issued scheduling grant/assignment to the IAB node's child node or WDs, the scheduling collision can be resolved in a pre-defined/on-demand manner.

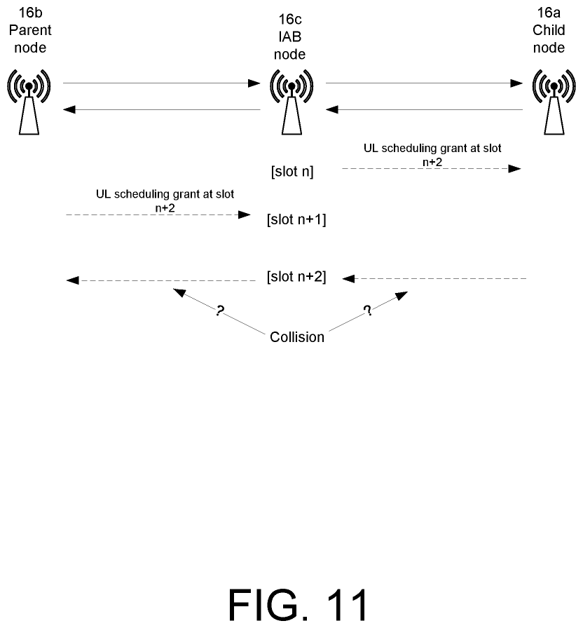

FIG. 11 is a diagram showing a child node 16a, a parent node 16b and an IAB node 16c. As exemplified in FIG. 11 where each time resource in the sets is one slot, collision may happen between the scheduling grants/assignments of the parent node 16b and the IAB node 16c. In this example, slot n+2 is not restricted by the parent node (i.e., the slot does not belong to any of the three sets), therefore the IAB node 16c can either assign it to UL or DL to its child links.

If the collision happens between the scheduling grant available for the UL parent backhaul and the already issued scheduling grant for UL child backhaul, or the UL data available, some embodiments provide at least one of two solutions:
Solution 1: transmit on UL parent backhaul and ignore the possible UL transmission from child links;
Solution 2: ignore the scheduling grant from the parent node 16b and do not transmit on UL parent backhaul.

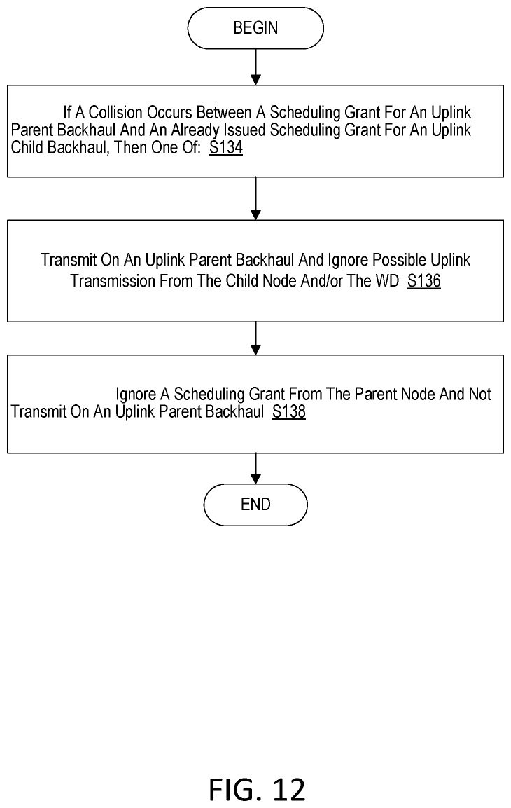

The operation of the IAB node 16c to resolve a scheduling collision between an UL parent backhaul grant and an UL child backhaul grant for a time resource is illustrated in FIG. 12. The time resource may be a time resource not constrained by the parent node 16b (i.e. a time resource not belonging to any of Set-1, Set-2 or Set-3). The process includes, if a collision occurs between a scheduling grant for an uplink parent backhaul and an already issued scheduling grant for an uplink child backhaul, as determined by the IAB unit 32, then one of: transmitting on an uplink parent backhaul and ignore possible uplink transmission from the child node and/or the WD; and ignoring a scheduling grant from the parent node and not transmit on an uplink parent backhaul.

A similar collision may happen between the scheduling grant available for the UL parent backhaul, and the already issued scheduling assignment for DL child backhaul or DL access. If the two links are on different panels, the IAB node 16c may transmit both to UL parent backhaul and DL child backhaul/access. Otherwise, the IAB node 16c should to determine which link to drop due to the transmit-timing misalignment. Since in this case, both UL and DL data are transmitted from the IAB node 16c, there is no interference issue as in the previous case. The IAB node 16c may decide based on the real-time demands or priority, at least one of the following two solutions:
Solution 1: only transmit on UL parent backhaul;
Solution 2: only transmit on DL child links.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

### Abbreviation Explanation

IAB Integrated access and backhaul

MT Mobile terminal

UE User equipment

TDM Time-domain multiplexing

FDM Frequency-domain multiplexing

SDM Spatial domain multiplexing

UL Uplink

DL Downlink

CLI Cross-link interference

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

A set of example embodiments will now be described:

Embodiment A1. A network node configured as an integrated access backhaul, IAB, node to communicate with a parent node and a child node and/or a wireless device (WD), the network node configured to, and/or comprising a radio interface and/or comprising processing circuitry configured to:
if a collision occurs between a scheduling grant for an uplink parent backhaul and an already issued scheduling grant for an uplink child backhaul, then one of:
   transmit on an uplink parent backhaul and ignore possible uplink transmission from the child node and/or the WD; and
   ignore a scheduling grant from the parent node and not transmit on an uplink parent backhaul.

Embodiment A2. The network node of Embodiment A1, wherein, if a collision occurs between a scheduling grant available for an uplink parent backhaul and an already issued scheduling assignment for a downlink child backhaul or downlink access, then one of:
only transmit on the uplink parent backhaul; and
only transmit on downlink child links.

Embodiment A3. The network node of Embodiment A1, wherein the network node is configured with time resources belonging to none, one or multiples of:
a Set-1 containing time resources on which the network node is capable of receiving a downlink backhaul;
a Set-2 containing time resources on which an uplink parent backhaul is scheduled; and
a Set-3 containing time resources on which the network node schedules an uplink transmission from the one of the child node and the WD.

Embodiment B1. A method implemented in a network node configured as an integrated access backhaul, IAB, node to communicate with a parent node and a child node and or a wireless device (WD), the method comprising:
if a collision occurs between a scheduling grant for an uplink parent backhaul and an already issued scheduling grant for an uplink child backhaul, then one of:
   transmitting on an uplink parent backhaul and ignore possible uplink transmission from the child node and/or the WD; and
   ignoring a scheduling grant from the parent node and not transmit on an uplink parent backhaul.

Embodiment B2. The method of Embodiment B1, wherein, if a collision occurs between a scheduling grant available for an uplink parent backhaul and an already issued scheduling assignment for a downlink child backhaul or downlink access, then the method includes one of:
only transmitting on the uplink parent backhaul; and
only transmitting on downlink child links.

Embodiment B3. The method of Embodiment B1, wherein the network node is configured with time resources belonging to none, one or multiples of:
a Set-1 containing time resources on which the network node is capable of receiving a downlink backhaul;
a Set-2 containing time resources on which an uplink parent backhaul is scheduled; and
a Set-3 containing time resources on which the network node schedules an uplink transmission from the one of the child node and the WD.

Embodiment C1. A parent node configured to communicate with an integrated access backhaul, IAB, node, the parent node configured to, and/or comprising a radio interface and/or processing circuitry configured to:
signal information to the IAB node, the information concerning at least one of:
   a Set-1 containing time resources on which the IAB node is capable of receiving a downlink backhaul;
   a Set-2 containing time resources on which an uplink parent backhaul is scheduled; and
   a Set-3 containing time resources on which the IAB schedules an uplink transmission from the one of a child node and a WD.

Embodiment D1. A method implemented in a parent node configured to communicate with an integrated access backhaul, IAB, node, the method comprising:
signaling information to the IAB node, the information concerning at least one of:
   a Set-1 containing time resources on which the IAB node is capable of receiving a downlink backhaul;
   a Set-2 containing time resources on which an uplink parent backhaul is scheduled; and
   a Set-3 containing time resources on which the IAB schedules an uplink transmission from the one of a child node and a WD.

1. A method implemented at an integrated access backhaul, IAB, node configured to communicate with a parent node and a child node, the method comprising:
receiving from the parent node information indicating:
a first set of time resources in which the IAB node is to be capable of receiving a downlink backhaul; and
a second set of time resources in which an uplink parent backhaul might be scheduled; and
in response to receiving information indicating the first set of time resources, scheduling links to the child node within the time resources of the first set depending on the capabilities of the IAB node.

2. (canceled)

3. The method of claim 1, further comprising, in response to receiving information indicating the first set of time resources, configuring the IAB node for the time resources of the first set to receive a downlink backhaul.

4. The method of claim 3, comprising configuring the IAB node for the time resources of the first set to receive a downlink backhaul by:
having a receiver of the IAB node active; and
configuring a receiver antenna of the IAB node to be able to receive a downlink backhaul from the parent node.

5. (canceled)

6. The method of claim 1, further comprising scheduling at least one of uplink and downlink links to the child node for the time resources of the first set depending on the capabilities of the IAB node.

7. The method of claim 1, further comprising, in response to receiving information indicating the first set of time resources and a scheduling grant for uplink transmission to the parent node for a time resource within the first set, performing an uplink transmission to the parent node during the scheduled time resource.

8. The method claim 1, further comprising, in response to receiving information indicating the second set of time resources, controlling scheduling of uplink transmissions from the child node to the IAB node for time resources within the second set.

9. The method of claim 8, further comprising preventing scheduling of uplink transmissions from the child node to the IAB node for time resources within the second set.

10. The method of claim 8, further comprising reducing the probability of scheduling uplink transmissions from the child node to the IAB node for time resources within the second set compared to if those time resources were not included within the second set.

11. The method of claim 33, further comprising, in response to receiving information indicating the third set of time resources, scheduling uplink transmissions from the child node or wireless device only within time resources of the third set.

12. The method of claim 33, further comprising, in response to receiving information indicating the third set of time resources, identifying available time resources to be used for downlink transmissions to the wireless device.

13. The method of claim 33, further comprising, in response to receiving an uplink scheduling grant from the parent node for a time resource not belonging to the one of the first and second sets and for which the IAB node has previously scheduled an uplink grant to the one of the child node and the wireless device one of:
transmitting on an uplink parent backhaul in the time resource and ignoring uplink transmissions from the one of the child node and the wireless device; and
not transmitting on the uplink parent haul within the time resource.

14. The method of claim 33, further comprising, in response to receiving an uplink scheduling grant from the parent node for a time resource not belonging to the one of the first and the second and the third sets and for which the IAB node has previously issued a downlink scheduling assignment to one of a child node and wireless device, one of:
transmitting only on the uplink parent backhaul for the time resource; and
only transmitting on the downlink to the child node or wireless device for the time resource.

15. An integrated access backhaul, IAB, node configured to communicate with at least one of a parent node, a child node and a wireless device, the IAB node being configured to:
receive from the parent node information indicating:
a first set of time resources in which the IAB node is to be capable of receiving a downlink backhaul; and
a second set of time resources in which an uplink parent backhaul might be scheduled;
in response to receiving information indicating the first set of time resources, schedule links to the child node within the time resources of the first set depending on the capabilities of the IAB node.

16.-20. (canceled)

21. The IAB node of claim 15, further configured to, in response to receiving information indicating the first set of time resources and a scheduling grant for uplink transmission to the parent node for a time resource within the first set, perform an uplink transmission to the parent node during the scheduled time resource.

22. The IAB node of claim 15, further configured to, in response to receiving information indicating the second set of time resources, prevent scheduling of uplink transmissions from the child node to the IAB node for time resources within the second set.

23. (canceled)

24. (canceled)

25. The IAB node of claim 34, further configured to, in response to receiving information indicating the third set of time resources, schedule uplink transmissions from one of the child node and the wireless device only within time resources of the third set.

26. The IAB node of claim 34, further configured to, in response to receiving information indicating the third set of time resources, identify available time resources to be used for downlink transmissions to the wireless device.

27.-30. (canceled)

31. A non-transitory computer readable medium including instructions which, when executed by a processor of an integrated access backhaul network node configured to communicate with a parent node and child node, cause the processor to receive from a parent node information indicating:
a first set of time resources in which the IAB node is to be capable of receiving a downlink backhaul;
a second set of time resources in which an uplink parent backhaul might be scheduled; and
in response to receiving information indicating the first set of time resources, scheduling links to the child node within the time resources of the first set depending on the capabilities of the IAB node.

32. (canceled)

33. The method of claim 1, further comprising receiving a third set of time resources in which the IAB node is permitted to schedule an uplink transmission from a wireless device, WD.

34. The IAB node of claim 15, further configured to receive a third set of time resources in which the IAB node is permitted to schedule an uplink transmission from a wireless device, WD.
